(19) United States
(12) Patent Application Publication
(10) Pub. No.: US 2025/0115089 A1
(43) Pub. Date: Apr. 10, 2025

(54) BALL STUD JOINT FOR A CHASSIS, METHOD FOR PRODUCING A CLOSURE COVER FOR SUCH A BALL STUD JOINT, AND METHOD FOR PRODUCING A BALL STUD JOINT WITH A ACCORDINGLY PRODUCED CLOSURE COVER

(71) Applicant: ZF Friedrichshafen AG, Friedrichshafen (DE)

(72) Inventor: Konstantin Rempel, Espelkamp (DE)

(73) Assignee: ZF Friedrichshafen AG, Friedrichshafen (DE)

(21) Appl. No.: 18/908,326

(22) Filed: Oct. 7, 2024

(30) Foreign Application Priority Data
Oct. 9, 2023 (DE) 10 2023 209 829.6

(51) Int. Cl. B60G 7/00

(52) U.S. Cl. CPC B60G 7/005; B60G 2204/416

(57) ABSTRACT

The invention relates to a ball stud joint (1) for a chassis of a vehicle, the ball stud joint having a ball stud (3) which is fitted and can move in a joint housing (7), where the joint housing (7) has an assembly opening (9) that is closed by a closure cover (14). A cover rim (15) of the closure cover (14) is held fast on the joint housing (7) by means of a beaded and/or flanged holding edge (11) of the joint housing (7). To avoid or at least reduce a notch effect between the cover rim (15) and the holding edge (11), the ball stud joint (1) is characterized in that the cover rim (11) of the closure cover (14) is formed by a simple fold (16).

### RELATED APPLICATIONS

This application claims the benefit of and right of priority under 35 U.S.C. § 119 to German Patent Application no. 10 2023 209 829.6, filed on 9 Oct. 2023, the contents of which are incorporated herein by reference in its entirety.

### FIELD OF THE DISCLOSURE

The invention relates to a ball stud joint for a chassis of a vehicle, with a ball stud having a joint ball and a stud section, wherein the joint ball is fitted in and is able to move in a bearing shell, the bearing shell is arranged in a joint housing, and the ball stud extends through a joint housing opening in the joint housing so that the stud section is located outside the joint housing and the bearing shell, wherein the joint housing has an assembly opening which is closed by a closure cover, and a cover rim of the closure cover is fixed onto the joint housing by means of a beaded and/or flanged holding edge of the joint housing. In addition, the invention relates to a method for producing a closure cover for such a ball stud joint and a method for producing a ball stud joint with a closure cover produced in that way.

### BACKGROUND

Such a ball stud joint is known from DE 10 2004 001 465 A1. In that case there is a risk, in particular with joint housings made of aluminum, that an undesired notch effect may take place between the rim of the cover and the retaining edge. This can result in undesired weakening of the material, or cracks in the retaining edge, which have an adverse effect on the useful life of the ball stud joint. To reduce this undesired notch effect, the edges of the cover rim can be ground and/or polished. However, that entails a separate and therefore additional production step in the production of the closure cover.

### SUMMARY

The purpose of the present invention is to develop further a ball stud joint and/or a method of the type mentioned to begin with, in such manner that a notch effect between the cover rim and the retaining edge can be avoided or at least reduced. Preferably an additional or separate production step in the production of the closure cover and/or the ball stud joint should be avoided. In particular an alternative embodiment should be provided.

The objective of the invention is achieved by a ball stud joint, a method of producing a ball stud joint, and a method of producing a closure cover as disclosed herein. Alternate embodiments and preferred further developments of the invention will be apparent in light of the present disclosure.

The ball stud joint is designed for use in a chassis of a vehicle, in particular a motor vehicle. In automotive engineering, ball stud joints can be used in many ways. Particularly in the chassis, ball stud joints serve to articulate chassis components—such as steering components, wheel carriers, track-rods, or the like—to one another, to the vehicle body, or to an axle carrier attached thereto.

The ball stud joint comprises a ball stud. In particular, the ball stud is made of metal. The ball stud comprises a joint ball and a stud section. The ball stud can be made integrally in one piece. The joint ball of the ball stud is fitted into and can move in a bearing shell.

The bearing shell is arranged in a joint housing. The joint housing can be made as a separate component. Alternatively, the joint housing can be in the form of a part or a section of a chassis component. The ball stud extends through a housing opening of the joint housing so that the stud section is outside the joint housing and the bearing shell. In particular, the joint housing is associated with a first chassis component and the stud section is associated with a second chassis component.

In particular, a movable fitting of the ball stud in the bearing shell is understood to mean that it can swivel, tilt, and/or rotate. “Tipping” or “tilting” of the ball stud is in particular understood to mean a movement of the ball stud relative to the joint housing and/or the bearing shell in which a change takes place in an angle enclosed between a longitudinal axis of the ball stud and a longitudinal housing axis of the joint housing. Preferably, the tipping or tilting takes place about the mid-point of a bearing area. The tilt angle, or a tilt angle of the inside portion of the joint, is in particular the angle, or an angle enclosed between the longitudinal axis of the ball stud and the longitudinal housing axis. In the non-tilted position of the ball stud, the tilt angle is preferably zero and/or the longitudinal axis of the ball stud coincides with the longitudinal housing axis.

“Rotation” or “twisting” of the ball stud is understood to mean a movement of the ball stud in which, relative to the joint housing, the ball stud rotates about the longitudinal axis of the ball stud. Preferably, the longitudinal housing axis coincides with a central longitudinal axis of the closure cover.

The joint housing has an assembly opening, and the assembly opening is closed by a closure cover. A cover rim of the closure cover is fixed onto the joint housing by means of a beaded and/or flanged holding edge of the joint housing.

According to the invention, the cover rim of the closure cover is formed by a simple folding process.

In this, owing to the simple folding, the notch effect between the cover rim and the holding edge is advantageously reduced. The folding is explicitly a single fold and not a multiple fold. Such single folding can be produced simply and inexpensively. Preferably, the simple fold can be integrated in a production step for producing the closure cover. The simply folded cover rim can enable the use of a material for the closure cover whose thickness is smaller than would be necessary in a closure cover without a fold in order to have the required rigidity.

In particular, with a simple fold a section of the cover rim is folded through 180° over another section of the cover rim. Preferably, with the simple fold the thickness of the cover rim is twice the material thickness of the closure cover away from the cover rim. The simple fold can be made on an underside or an upper side of the closure cover.

According to a further embodiment the cover rim has an outer side directed radially outward relative to the central longitudinal axis of the closure cover. By virtue of the simple fold the outer side is rounded and/or curved. Thus, thanks to the simple fold edges in the area of the outer circumference of the closure cover are avoided, and accordingly subsequent polishing and/or grinding of such edges is not necessary. A notch effect between the cover rim and the holding edge of the joint housing is avoided or at least reduced thanks to the rounded and/or curved form of the outer side.

The outer side of the simply folded cover rim can have a convex cross section, in particular curved. Preferably, relative to the central longitudinal axis of the closure cover, the outer side is therefore convex and/or curved outward.

In particular, the closure cover extends transversely or perpendicularly relative to the central longitudinal axis of the closure cover. The closure cover can be made rotationally symmetrical about the central longitudinal axis of the closure cover.

The outer side can have a semicircular cross-section, in particular with a constant radius. Preferably, the outer side has a radius that corresponds to the thickness of the unfolded material of the closure cover, particularly outside the area of the singly folded cover rim.

In a further development, the holding edge of the joint housing has an inner side directed radially inward relative to the central longitudinal axis of the closure cover. The inner side has a shape that correspond to the shape of the outer side of the cover rim. In particular, the inner side of the holding edge is in shape-enclosing contact with the outer side of the cover rim. Preferably, the simply folded cover rim is embraced by the holding edge, whereby the closure cover is secured onto the joint housing.

In particular, the inner side has a shape that corresponds to the shape of the outer side of the cover rim, with a concave and/or curved and/or semicircular cross-section.

Preferably the joint housing is made of a metal, such as aluminum. In particular the closure cover is made from a shaped metal sheet. Particularly in a central area the closure cover can have a bead or raised section. This bead or raised section can improve the rigidity of the closure cover. In that way a necessary material thickness of the closure cover, particularly in combination with the simply folded cover rim, can be reduced.

Particularly advantageous is a method for producing a closure cover for a ball stud joint according to the invention, wherein the closure cover is made from a metal sheet in that the metal sheet is deformed by a shaping tool to produce a specified shape. At the same time, to produce the cover rim the metal sheet is simply folded. Thereby, the outer side of the cover rim is given a rounded and/or curved cross-section. Thus, the closure cover, including the simply folded cover rim, is produced in a single production step. No finish-machining of the closure cover is required.

In addition, an advantageous method for producing a ball stud joint according to the invention is one in which the closure cover is produced first by the method described above. Then, the bearing shell together with the ball stud are fitted into the joint housing through the assembly opening. After that, the assembly opening is closed by means of the closure cover, for which purpose the holding edge of the joint housing is beaded and/or flanged in order to retain the closure cover. Thereby an inner side of the holding edge is formed with a rounded and/or curved cross-section whose shape corresponds to that of the outer side of the cover rim.

In particular, the ball stud joint produced in accordance with the method according to the invention is a ball stud joint according to the invention as described earlier. Preferably the method is developed further in accordance with the design features explained in connection with the ball stud joint according to the invention described herein. Furthermore, the ball stud joint described herein can be developed further in accordance with the design features explained in connection with the method.

### BRIEF DESCRIPTION OF THE DRAWINGS

Below, the invention is explained in greater detail with reference to the figures. In the figures, the same indexes denote the same, similar, or functionally equivalent components or elements. The figures show:

FIG. 1: A sectioned side view of a ball stud joint which is not according to the invention, and

FIG. 2: Part of a sectioned side view of a closure cover for a ball stud joint according to the invention.

### DETAILED DESCRIPTION

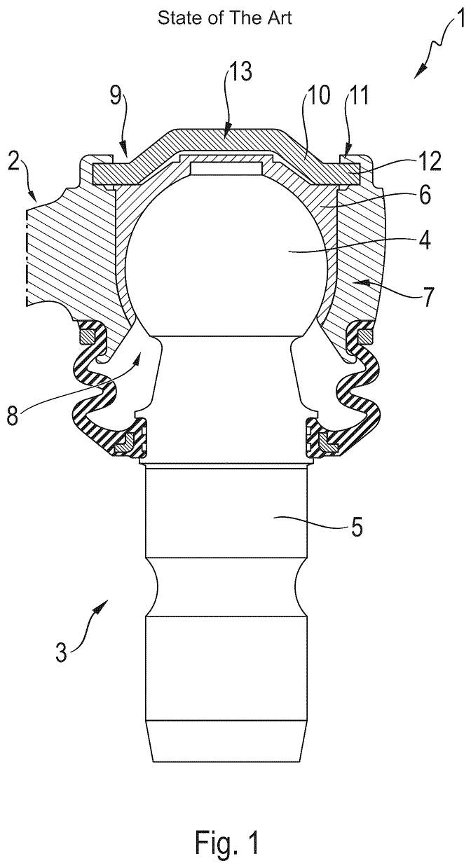

FIG. 1 shows a sectioned side view of a ball stud joint 1, which is not according to the present invention, but according to the prior art. The ball stud joint 1 is designed for use in a chassis (not shown) of a vehicle, for example, in order to articulate a first chassis component 2 to a second chassis component (not shown).

The ball stud joint 1 has a ball stud 3. The ball stud 3 has a joint ball 4 and a stud section 5 extending away from the joint ball 4. The joint ball 4 is fitted and able to move in a bearing shell 6. Whereas the ball stud 3 is made of a metal, the bearing shell 6 is made of a low-friction plastic. Furthermore, the bearing shell 6 is fitted in or fixed into a joint housing 7.

In this example embodiment, the joint housing 7 is in the form of an integral or one-piece part of the first chassis component 2. Alternatively, the joint housing 7 can be a standalone component which is fitted into an appropriately designed housing holder in a chassis component.

The ball stud 3 extends through a housing opening 8 of the joint housing 7. Thus, the stud section 5 is located outside the joint housing 7 and the bearing shell 6.

Furthermore, the joint housing 7 has an assembly opening 9. To produce the ball stud joint 1, the bearing shell 6 together with the ball stud 3 are inserted though the assembly opening 9 into the joint housing 7. After that, the assembly opening 9 is closed by a closure cover 10. For that purpose, in this example embodiment, a holding edge 11 is rolled over all round the assembly opening 9 of the joint housing 7.

In this case, the holding edge 11 of the joint housing 7 embraces a cover rim 12 of the closure cover 10. The cover rim 12 has edges which result in an undesired notch effect between the cover rim 12 and the holding edge 11 of the joint housing 7. This can lead to undesired weakening of the material or cracking of the holding edge 11, which can adversely affect the useful life of the ball stud joint 1.

In this example embodiment, the closure cover 10 has a bead or raised section 13 in a central area. This raised section 13 increases the rigidity of the closure cover 10. In that way, the material thickness required in order to achieve a specified rigidity of the closure cover 10 can be reduced.

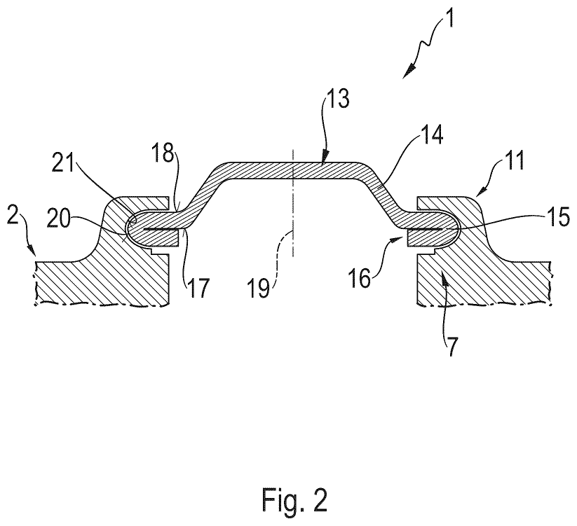

FIG. 2 shows a sectioned side view of a closure cover 14 for a ball stud joint 1, according to the invention. The essential structure of the ball stud joint 1 with the closure cover 14 corresponds to that of the ball stud joint in FIG. 1. Thus, to avoid repetitions reference should also be made to the previous description. In this case, for the sake of greater clarity, parts of the ball stud joint 1 such as the bearing shell 6 and the ball stud 3 have been omitted.

Other than in the ball stud joint according to FIG. 1, the closure cover 14 of the solution according to the present invention has a cover rim 15 which is formed by a simple fold 16. The production of such a simple fold 16 can be integrated into a single production or working step for producing the closure cover, so that no additional finish-machining is needed, such as smoothing-off of edges. Furthermore, the simply folded cover rim 15 makes it possible to use a material for the closure cover 14 which is thinner than would be necessary for a closure cover without a fold in order to obtain the required rigidity.

For the simple fold 16 a part of the closure cover 14 is folded over another part of the cover rim 15. In this example embodiment the cover rim 15 with its simple fold 16 has a thickness that corresponds to twice the material thickness of the closure cover away from the cover rim 15. Moreover, in this example embodiment the single fold 16 is formed on an underside of the closure cover 14. Alternatively, the fold can be formed on an upper side 18 of the closure cover 14.

The closure cover 14 has a central longitudinal axis 19. Here, the closure cover 14 extends perpendicularly to the central longitudinal axis 19. In this example embodiment, the closure cover 14 is formed rotationally symmetrically around the central longitudinal axis 19.

The cover rim 15 has an outer side 20 directed radially outward relative to the central longitudinal axis 19. Owing to the simple fold 16, the outer side 20 is rounded or curved. Thus, thanks to the simple fold 16, edges are avoided in the area of the outer circumference of the closure cover 14, whereby at the same time a notch effect between the cover rim 15 and the holding edge 11 of the joint housing 7 is avoided or at least reduced.

More specifically, the outer side 20 of the simply folded cover rim 15 has a convex cross-section so that the outer side 20 is curved in an outward arch relative to the central longitudinal axis 19. Here, in this example embodiment, the cross-section has a semicircular shape with a constant radius. The radius of the outer side 20 in this example corresponds to the thickness of an unfolded material of the closure cover 14.

The holding edge 11 of the joint housing 7 has an inner side 21 directed radially inward relative to the central longitudinal axis 19. The shape of the inner side 21 corresponds to that of the outer side 20 of the cover rim 15. Accordingly, the inner side 21 has a concave cross-section relative to the central longitudinal axis 19, whose shape corresponds to that of the outer side 20. Thus, the inner side 21 of the holding edge 11 is in interlocking contact with the outer side 20 of the cover rim 15. In this case then, the simply folded cover rim 15 is embraced by the holding edge 11, whereby the closure cover 14 is held fast onto the joint housing 7.

### INDEXES

1 Ball stud joint
2 Chassis component
3 Ball stud
4 Joint ball
5 Stud section
6 Bearing shell
7 Joint housing
8 Housing opening
9 Assembly opening
10 Closure cover
11 Holding edge
12 Cover rim
13 Raised section
14 Closure cover
15 Cover rim
16 Simple fold
17 Underside
18 Upper side
19 Central longitudinal axis
20 Outer side
21 Inner side

1. A ball stud joint for a chassis of a vehicle, the ball stud joint comprising:
a joint housing (7) having a beaded and/or flanged holding edge (11) and defining a housing opening (8) and an assembly opening (9);
a bearing shell (6) arranged in the joint housing (7);
a ball stud (3) that comprises a joint ball (4) and a stud section (5), wherein the joint ball (4) is fitted into and can move in the bearing shell (6), the ball stud (3) extending through the housing opening (8) of the joint housing (7) so that the stud section (5) is located outside the joint housing (7) and the bearing shell (6);
a closure cover (14) closing the assembly opening (9), the closure cover having a cover rim (15) formed by a simple fold (16), the closure cover (14) held onto the joint housing (7) by means of the beaded and/or flanged holding edge (11) of the joint housing (7).

2. The ball stud joint according to claim 1, wherein the cover rim (11) has an outer side (20) directed outward relative to a central longitudinal axis (19) of the closure cover (14), and by virtue of the simple fold (16) the outer side (20) is rounded and/or curved.

3. The ball stud joint according to claim 1, the outer side (20) has a convex cross-section.

4. The ball stud joint according to claim 3, wherein the outer side (20) has a semicircular cross-section with a constant radius.

5. The ball stud joint according to claim 2, wherein the holding edge (11) of the joint housing (7) has an inner side directed inward relative to the central longitudinal axis (19) of the closure cover (14), and the shape of the inner side (21) corresponds to the shape of the outside (20) of the cover rim (15).

6. The ball stud joint according to claim 5, wherein the inner side (21) has a concave cross-section.

7. The ball stud joint according to claim 1, wherein the joint housing (7) is made of a metal.

8. A method for producing a closure cover for a ball stud joint (1) according to claim 1, comprising:
forming the closure cover (14) from a metal sheet;
shaping the metal sheet by means of a deforming tool into a specified shape; and
shaping, at the same time, the cover rim (15) and an outer side (20) of the cover rim (15) by virtue of the single fold (16) of the metal sheet to obtain a rounded and/or curved cross-section.

9. A method for producing a ball stud joint (1) according to claim 1, comprising:
forming a closure cover (14) from a metal sheet;
shaping the metal sheet by means of a deforming tool into a specified shape;
shaping, at the same time, the cover rim (15) and an outer side (20) of the cover rim (15) by virtue of the single fold (16) of the metal sheet to obtain a rounded and/or curved cross-section
inserting the bearing shell (6) together with the ball stud (3) into the joint housing (7) through the assembly opening (9);
closing the assembly opening (9) by the closure cover (14), for which purpose the holding edge (11) of the joint housing (7) is beaded and/or flanged in order to hold the closure cover (14) fast; and
shaping an inner side (21) of the holding edge (11) with a rounded and/or curved cross-section that corresponds to the shape of the outer side (20) of the cover rim (15).

10. The ball stud joint according to claim 4, wherein the outer side (20) has a radius that corresponds to the thickness of an unfolded material of the closure cover (14).

11. The ball stud joint according to claim 5, wherein the inner side (21) has a semicircular cross-section.

12. The ball stud joint according to claim 7, wherein the joint housing is made of sheet metal.

13. The ball stud joint according to claim 7, wherein the metal comprises aluminum.
